(19) United States
(12) Patent Application Publication
(10) Pub. No.: US 2018/0108253 A1
(43) Pub. Date: Apr. 19, 2018

(54) Vehicle and Control Method Thereof

(71) Applicants: Hyundai Motor Company, Seoul (KR); Hyundai Dymos Incorporated, Seosan-si (KR); Mediazen, Inc., Seongnam-si (KR)

(72) Inventors: Taehyung Kim, Hwaseong-si (KR); Byeong Seon Son, Hwaseong-si (KR); Gil Ju Kim, Seoul (KR); JunYoung Yun, Hwaseong-si (KR); Seon Chae Na, Yongin-si (KR); Deuk Kyu Byun, Gunpo-si (KR); Min-Kyu Song, Yongin-si (KR)

(21) Appl. No.: 15/381,989

(22) Filed: Dec. 16, 2016

(30) Foreign Application Priority Data
Oct. 19, 2016 (KR) 10-2016-0135631

(51) Int. Cl. G08G 1/0965; G09B 21/00

(52) U.S. Cl. CPC G08G 1/0965; G09B 21/009

(57) ABSTRACT

Disclosed herein is a vehicle that includes a sound receiver to receive a sound signal, a controller, and a memory storing a program to be executed in the controller. The program includes instructions to estimate an alarm sound model of the sound signal by determining an alarm sound model matching the sound signal among at least one alarm sound model stored beforehand.

### CROSS-REFERENCE TO RELATED APPLICATIONS

This application claims the benefit of Korean Patent Application No. 10-2016-0135631, filed on Oct. 19, 2016 in the Korean Intellectual Property Office, the disclosure of which is incorporated herein by reference.

### TECHNICAL FIELD

Embodiments of the present disclosure relate to a vehicle, and a method of controlling the same.

### BACKGROUND

A vehicle is a transportation device running on the road or the railroad using fossil fuel, electric power, or the like as a power source.

Recently, the need of the hearing impaired or people whose hearing is diminished to drive a vehicle has increased. However, existing vehicles do not appropriately reflect the need of the hearing impaired and the people whose hearing is diminished (hereinafter referred to as hearing-impaired drivers).

For example, a hearing-impaired driver may not be able to notice other vehicles' horn sound in the vicinity thereof. In this case, an accident is very likely to occur.

Thus, there is a growing need to develop a vehicle capable of exactly determining alarm sound that a driver should notice, such as vehicles' horn sound in the vicinity thereof, the sound of a siren of an emergency vehicle, etc., and enabling the driver to appropriately notice and respond to the determined alarm sound.

### SUMMARY

Embodiments of the invention describe a vehicle capable of determining alarm sound in the vicinity thereof, and a method of controlling the same. Therefore, it is an aspect of the present disclosure to provide a vehicle capable of determining whether a sound signal received by the vehicle is alarm sound that a driver should notice, and a method of controlling the same.

Additional aspects of the disclosure will be set forth in part in the description which follows and, in part, will be obvious from the description, or may be learned by practice of the disclosure.

In accordance with one aspect of the present disclosure, a vehicle includes a sound receiver and a controller. The sound receiver may receive a sound signal. The controller may estimate an alarm sound model of the sound signal. The controller may estimate the alarm sound model of the sound signal by determining an alarm sound model matching the sound signal among at least one alarm sound model stored beforehand.

The vehicle may further include an output unit. The output unit may output an output corresponding to the alarm sound model.

The controller may estimate a direction in which the sound signal is transmitted, and the output unit may output an output corresponding to the direction in which the sound signal is transmitted and the alarm sound model.

A plurality of sound receivers may be provided. The controller may estimate a direction in which the sound signal is transmitted on the basis of a difference between points of time when a plurality of sound signals respectively received by the plurality of sound receivers reach.

A plurality of sound receivers may be provided. The controller may determine spatial coordinates of a position of a source of the sound signal using a generalized cross correlation (GCC) function of a plurality of sound signals respectively received by the plurality of sound receivers, and may estimate a direction in which the sound signal is transmitted on the basis of the spatial coordinates.

The direction in which the sound signal may be transmitted includes at least one of: a forward or backward direction of the vehicle; a left direction of the vehicle, and a right direction of the vehicle.

The alarm sound model may include at least one of a horn sound model and a siren sound model of another vehicle.

The vehicle may further include a storage unit to store the at least one alarm sound model. The controller may determine an alarm sound model matching the sound signal among the at least one alarm sound model stored in the storage unit.

The controller may estimate the alarm sound model of the sound signal by transforming a sound signal received for a predetermined time section into a frequency-domain sound signal, dividing a frequency band of the frequency-domain sound signal into sub-frequency bands, calculating energy of the sound signal in each of the sub-frequency bands to extract a feature vector of the sound signal, and determining an alarm sound model matching the feature vector of the sound signal.

The controller may extract the feature vector of the sound signal according to a Mel-frequency cepstrum coefficients (MFCC) method.

The controller may estimate the alarm sound model of the sound signal by transforming the sound signal into a model obtained by adding a Gaussian function to the sound signal, and determining an alarm sound model matching this model.

The controller may determine the alarm sound model matching the sound signal using at least one of a Gaussian mixture model (GMM) and a deep neural network (DNN).

The controller may determine intensity of the sound signal, and the output unit may output an output corresponding to the intensity of the sound signal and the alarm sound model.

The controller may increase intensity of an output to be output from the output unit or increases speed of the output when the intensity of the sound signal increases or is greater than or equal to a predetermined reference value, and may decrease the intensity or speed of the output when the intensity of the sound signal decreases or is less than the predetermined reference value.

The output unit may include a left output unit and a right output unit. The controller may control the left output unit to output an output when the direction in which the sound signal is transmitted is estimated to be the left direction of the vehicle, may control the right output unit to output an output when this direction is estimated to be the right direction of the vehicle, and may control the left and right output units to output an output when this direction is estimated to be the forward or backward direction of the vehicle.

The output unit may include a vibration output unit to output vibration corresponding to the direction in which the sound signal is transmitted and the alarm sound model.

The controller may change a driving speed of the vehicle based on the estimated alarm sound model.

In accordance with another aspect of the present disclosure, a method of controlling a vehicle may include: receiving a sound signal; and estimating an alarm sound model of the sound signal. The estimating of the alarm sound model of the sound signal comprises estimating the alarm sound model of the sound signal by determining an alarm sound model matching the sound signal among at least one alarm sound model stored beforehand.

The method may further include outputting an output corresponding to the alarm sound model.

The estimating of the alarm sound model may include estimating a direction in which the sound signal is transmitted, and the outputting the output may include outputting an output corresponding to the direction in which the sound signal is transmitted and the alarm sound model.

The estimating of the alarm sound model may include estimating a direction in which the sound signal is transmitted on the basis of a difference between points of time when a plurality of sound signals respectively received by a plurality of sound receivers reach, and the outputting of the output may include outputting an output corresponding to the direction in which the sound signal is transmitted and the alarm sound model.

Before the outputting of the output, the method may further include determining intensity of the sound signal, and the outputting of the output may include outputting an output corresponding to the intensity of the sound signal.

The outputting of the output may include controlling a left output unit to output an output when the direction in which the sound signal is transmitted is estimated to be a left direction of the vehicle, controlling a right output unit to output an output when this direction is estimated to be a right direction of the vehicle, and controlling the left and right output units to output an output when this direction is estimated to be a forward or backward direction of the vehicle.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a diagram illustrating the appearance of a vehicle in accordance with one embodiment.

FIG. 2 is a diagram illustrating an internal structure of a vehicle in accordance with one embodiment.

FIG. 3 is a control block diagram of a vehicle in accordance with an embodiment.

FIG. 4 is a diagram illustrating a vehicle capable of estimating a direction in which horn sound transmitted from another vehicle and the intensity of the horn sound, in accordance with an embodiment.

FIG. 5 is a flowchart of a process of extracting a feature vector of a sound signal, in accordance with an embodiment.

FIG. 6 is a conceptual diagram illustrating a process of determining an alarm sound model matching a received sound signal, in accordance with an embodiment.

FIG. 7 is a diagram illustrating examples of outputs of vibration output units of a vehicle in accordance with an embodiment.

FIG. 8 is a flowchart of a method of controlling a vehicle in accordance with an embodiment.

### DETAILED DESCRIPTION OF ILLUSTRATIVE EMBODIMENTS

The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. The progression of processing operations described is an example; however, the sequence of and/or operations is not limited to that set forth herein and may be changed as is known in the art, with the exception of operations necessarily occurring in a particular order. In addition, respective descriptions of well-known functions and constructions may be omitted for increased clarity and conciseness.

Additionally, exemplary embodiments will now be described more fully hereinafter with reference to the accompanying drawings. The exemplary embodiments may, however, be embodied in many different forms and should not be construed as being limited to the embodiments set forth herein. These embodiments are provided so that this disclosure will be thorough and complete and will fully convey the exemplary embodiments to those of ordinary skill in the art. Like numerals denote like elements throughout.

It will be understood that, although the terms first, second, etc. may be used herein to describe various elements, these elements should not be limited by these terms. These terms are only used to distinguish one element from another. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present.

The terminology used herein is for the purpose of describing particular embodiments only and is not intended to be limiting. As used herein, the singular forms “a,” “an,” and “the,” are intended to include the plural forms as well, unless the context clearly indicates otherwise.

Reference will now be made in detail to the exemplary embodiments of the present disclosure, examples of which are illustrated in the accompanying drawings, wherein like reference numerals refer to like elements throughout.

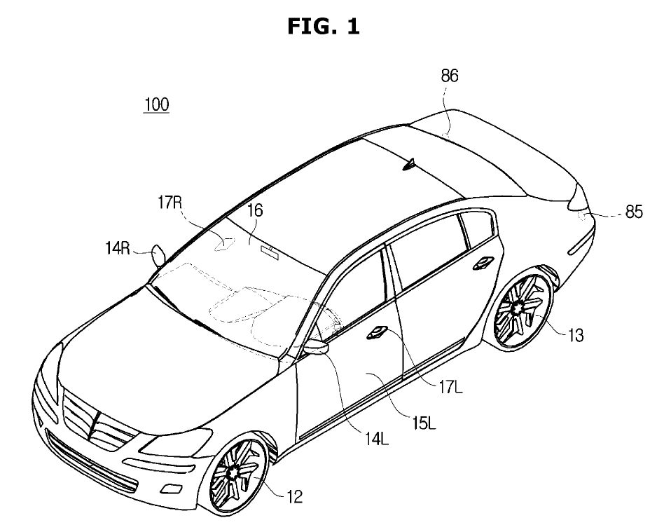

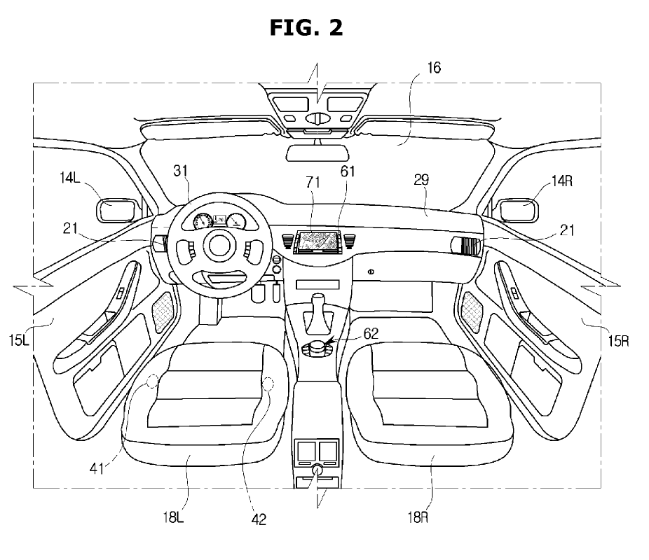

FIG. 1 is a diagram illustrating the appearance of a vehicle in accordance with one embodiment. FIG. 2 is a diagram illustrating an internal structure of a vehicle in accordance with one embodiment.

Referring to FIG. 1, the appearance of a vehicle 100 in accordance with one embodiment includes wheels 12 and 13 for moving the vehicle 100, a door 15L which shields the inside of the vehicle 100 from the outside, a front glass 16 through which a driver in the vehicle 100 may view a sight in front of the vehicle 100, and left and right side-view mirrors 14L and 14R through which the driver may view a sight behind the vehicle 100.

The wheels 12 and 13 include the front wheel 12 at the front of the vehicle 100 and the rear wheel 13 at the back of the vehicle 100. A driving device (not shown) inside the vehicle 100 provides turning force to the front wheel 12 or the rear wheel 13 so as to move the vehicle 100 in a forward or backward direction. The driving device may employ an engine which burns fossil fuel to generate turning force, or a motor which receives power from a condenser to generate turning force.

The door 15L and a door 15R (see FIG. 2) are provided at left and right sides of the vehicle 100 to be rotationally moved, whereby a driver or a passenger may get in the vehicle 100 when they are opened and the inside of the vehicle 100 may be shielded from the outside when they are closed. Furthermore, handles 17L, 17R may be provided at outer sides of the vehicle 100, through which the doors 15L and 15R (see FIG. 2) may be opened or closed.

The front glass 16 is provided at a front and upper side of a body of the vehicle 100, whereby a driver in the vehicle 100 may obtain visual information in front of the vehicle 100. The front glass 16 may be also referred to as a windshield glass.

The left and right side-view mirrors 14L and 14R include the left side-view mirror 14L at a left side of the vehicle 100 and the right side-view mirror 14R at a right side of the vehicle 100, whereby a driver in the vehicle 100 may obtain visual information at lateral and rear sides of the vehicle 100.

In addition, although not shown, the vehicle 100 may include sensor devices, such as a proximity sensor which senses an obstacle or other vehicles at a front, rear or lateral side of the vehicle 100, a rain sensor which senses precipitation and a precipitation rate, an illumination sensor which senses brightness of an external environment of the vehicle 100, etc.

The proximity sensor may transmit a sensing signal to a front, rear, or lateral side of the vehicle 100 and receive a signal reflected from an obstacle such as another vehicle. Whether an obstacle is present at the front, rear, or lateral side of the vehicle 100 may be sensed and the position of an obstacle may be detected on the basis of waveforms of the reflected signal.

Referring to FIG. 2, an audio/video navigation (AVN) display 71 and an AVN input unit 61 may be provided in a central region of a dashboard 29. The AVN display 71 may selectively display at least one among an audio screen, a video screen, and a navigation screen, and may further display various control screens related to the vehicle 100 or a screen related to additional functions of the vehicle 100. For example, the AVN display 71 may display a situation of the road, an obstacle, etc. at the front, rear, or lateral side of the vehicle 100 in the form of an image.

The AVN display 71 may be embodied as a liquid crystal display (LCD), a light-emitting diode (LED), a plasma display panel (PDP), an organic light-emitting diode (OLED), a cathode ray tube (CRT), or the like.

The AVN input unit 61 may be provided in the form of a hard key in a region adjacent to the AVN display 71. When the AVN display 71 is embodied as a touch screen type, the AVN input unit 61 may be provided in the form of a touch panel on a front surface of the AVN display 71.

A jog shuttle type center input unit 62 may be provided between a driver seat 18L and a passenger seat 18R. A driver may input a control command by turning the center input unit 62, applying pressure to the center input unit 62, or pushing the center input unit 62 in an upward, downward, left, or right direction.

A steering wheel 31 is provided on the dashboard 29 near the driver seat 18L.

The vehicle 100 in accordance with an embodiment may further include left and right vibration output units 41 and 42 provided at the driver seat 18L. The left and right vibration output units 41 and 42 may be provided at opposite sides of the driver seat 18L on which a driver sits, so that the driver may feel left and right vibrations when the driver sits on the driver seat 18L.

The vehicle 100 may include an air conditioning device to perform both heating and cooling, and control internal temperature of the vehicle 100 by discharging heated or cooled air via a vent 21.

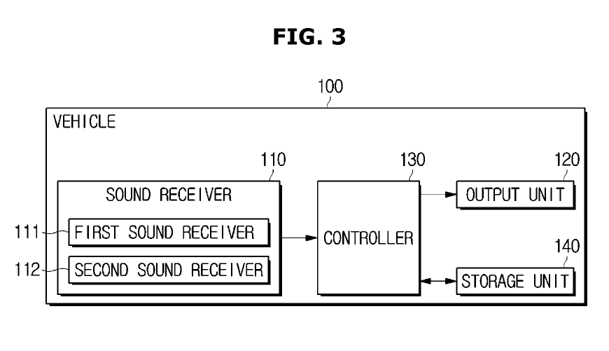

The structure of the vehicle 100 in accordance with an embodiment will be described in detail with reference to FIG. 3 below. FIG. 3 is a control block diagram of a vehicle in accordance with an embodiment.

Referring to FIG. 3, the vehicle 100 includes a sound receiver 110 which receives a sound signal, a controller 130 which estimates a direction in which the sound signal is transmitted and an alarm sound model of the sound signal, and an output unit 120 which outputs an output corresponding to the direction in which the sound signal is transmitted and the alarm sound model. The vehicle 100 may further include a storage unit 140 in which at least one alarm sound model is stored.

The sound receiver 110 receives a sound signal in the vicinity of the vehicle 100. Here, a range of the vicinity of the vehicle 100 may vary according to the performance of the sound receiver 110.

Examples of the sound signal include alarm sound that a driver should notice, e.g., horn sound generated by another vehicle in the vicinity of the vehicle 100, sound of a siren of an emergency vehicle, etc., and noise.

The sound receiver 110 may be embodied as a microphone or the like. The sound receiver 110 may be embodied as including first and second microphones 85 and 86 described above with reference to FIG. 1 but is not limited thereto.

Furthermore, a plurality of sound receivers 110 may be provided. For example, the sound receiver 110 may be embodied as including a first sound receiver 111 and a second sound receiver 112. The first and second sound receivers 111 and 112 independently collect a sound signal. Here, the first sound receiver 111 may be the first microphone 85 of FIG. 1, and the second sound receiver 112 may be the second microphone 86 of FIG. 1. Three or more sound receivers 110 may be provided. A case in which two sound receivers 110 are provided will be described below for convenience of explanation.

The output unit 120 may output an output in various forms which a hearing-impaired driver may sense according to a control signal from the controller 130.

In accordance with an embodiment, the output unit 120 may be embodied as a vibration output unit and may output vibration intensity or frequency differently according to a control signal from the controller 130. The output unit 120 may output an output in various forms which a driver may be able to recognize, e.g., in a tactile or visual form, as well as a vibration form.

The output unit 120 may include the left and right vibration output units 41 and 42 provided at the driver seat 18L described above with reference to FIG. 2. In this case, the left and right vibration output units 41 and 42 may output vibration according to the direction in which the sound signal is transmitted so that a driver may feel left or right vibration at a left or right side of the driver seat 18L.

The controller 130 generates a control signal for controlling the elements of the vehicle 100.

In accordance with an embodiment, the controller 130 may estimate the direction in which the sound signal is transmitted on the basis of the difference between points of time when a plurality of sound signals respectively received by the first and second sound receivers 111 and 112 reach. In this case, the controller 130 may determine spatial coordinates corresponding to the difference between the points of time when the plurality of sound signals reach using a generalized cross correlation (GCC) function of the plurality of sound signals, and estimate the direction in which the sound signal is transmitted on the basis of the spatial coordinates.

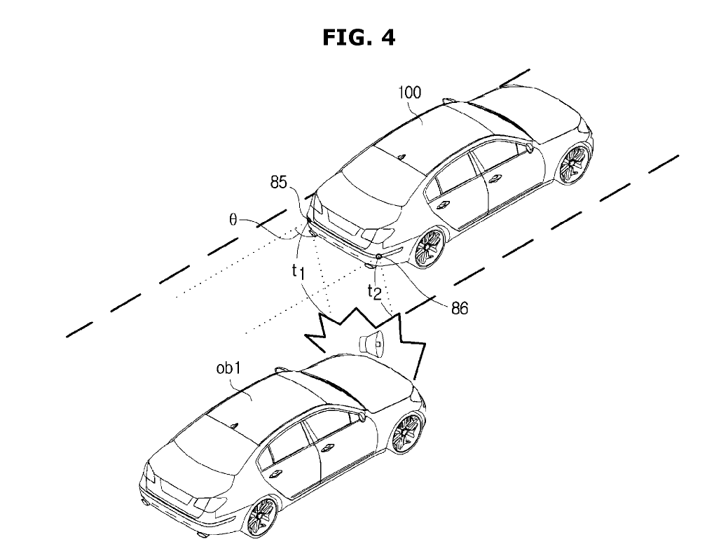

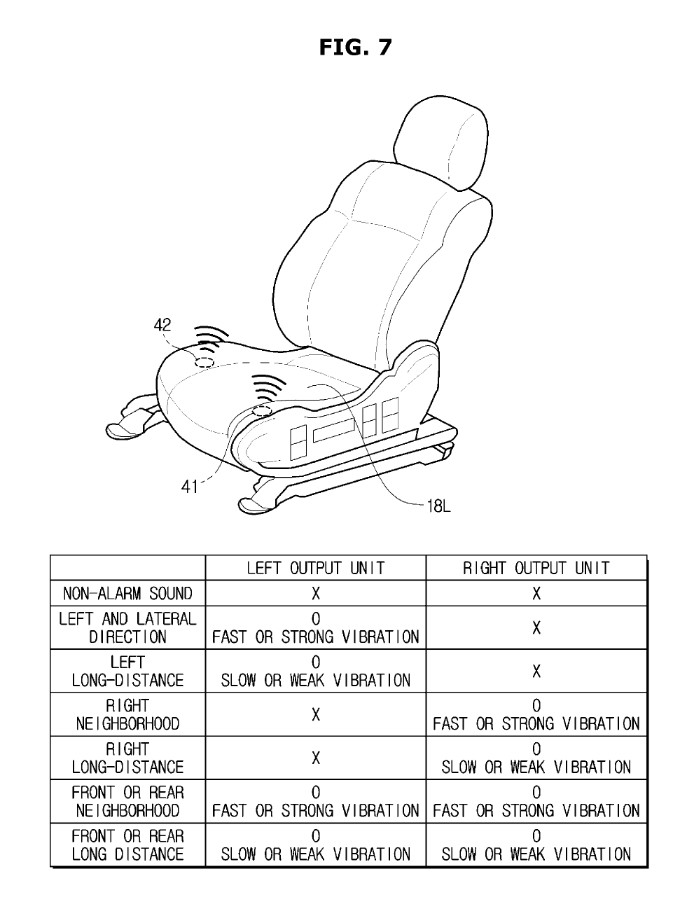

In this case, the controller 130 in accordance with an embodiment may estimate the direction in which the sound signal received by the sound receiver 110 is transmitted, and may control the output unit 120 to output an output corresponding to this direction. For example, the controller 130 may control the vibration output unit 41 of FIG. 2 which is a left vibration output unit to output an output when this direction is estimated to be a left direction of the vehicle 100, control the vibration output unit 42 of FIG. 2 which is a right vibration output unit to output an output when this direction is estimated to be a right direction of the vehicle 100, and control the left and right vibration output units 41 and 42 when this direction is estimated to be a forward or backward direction the vehicle 100, as will be described in detail with reference to FIGS. 4 and 7 below.

Furthermore, the controller 130 in accordance with an embodiment estimates an alarm sound model of the sound signal received by the sound receiver 110. In detail, the controller 130 may estimate an alarm sound model of the sound signal by determining an alarm sound model matching the received sound signal among at least one alarm sound model stored beforehand.

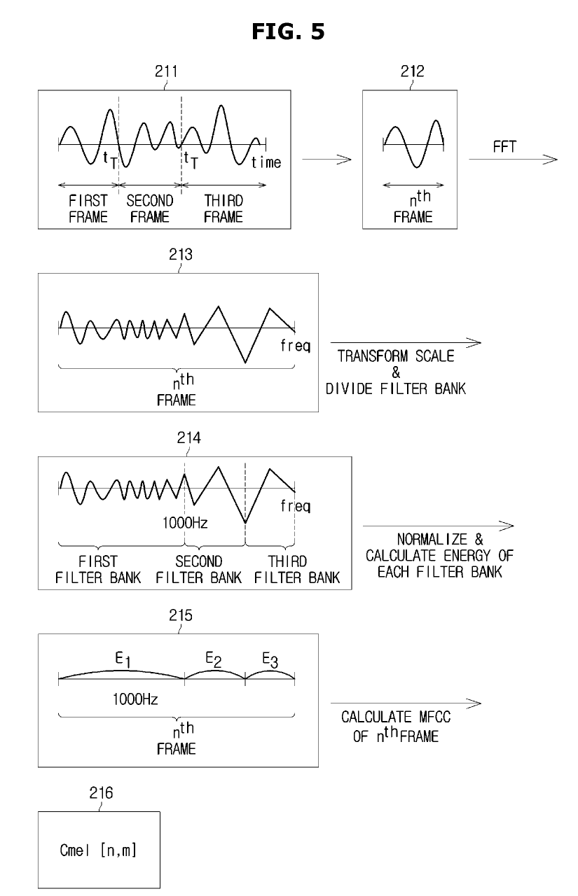

In this case, the controller 130 in accordance with an embodiment may control the output unit 120 to output an output corresponding to the direction in which the sound signal is transmitted or the intensity of the sound signal when a result of estimating an alarm sound model of the sound signal received by the sound receiver 110 reveals that the sound signal is alarm sound, and control the output unit 120 not to output an output when this result reveals that the sound signal is noise other than alarm sound, as will be described with reference to FIGS. 5 to 7 below.

Furthermore, the controller 130 in accordance with an embodiment may determine the intensity of the sound signal received by the sound receiver 110 and control the output unit 120 to output an output corresponding to the intensity of the sound signal. For example, the controller 130 may increase the intensity of vibration to be output from the left and right vibration output units 41 and 42 of FIG. 2 when the intensity of the sound signal is high.

The controller 130 may be embodied as including a memory (not shown) which stores data regarding an algorithm for controlling operations of the elements of the vehicle 100 or a program realizing the algorithm, and a processor (not shown) which performs the operation described above using the data stored in the memory. In this case, the memory and the processor may be embodied as different chips. Alternatively, the memory and the processor may be embodied as a single chip.

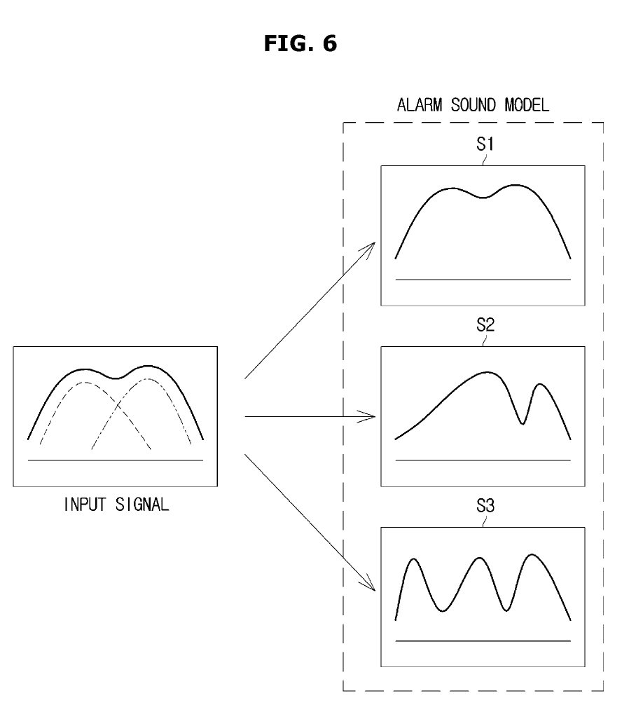

The storage unit 140 stores at least one alarm sound model. The at least one alarm sound model may include at least one of a horn sound model and a siren sound model. The at least one alarm sound model will be described with reference to FIG. 6 below.

The storage unit 140 may be embodied as including, but is not limited to, at least one among a nonvolatile memory device such as a cache, a read-only memory (ROM), a programmable ROM (PROM), an erasable programmable ROM (EPROM), an electrically erasable programmable ROM (EEPROM), or a flash memory; a volatile memory device such as a random access memory (RAM); and a storage medium such as a hard disk drive (HDD) or a compact-disc (CD)-ROM. The storage unit 140 may be a memory which is a chip separated from the processor described above in relation to the controller 130. Alternatively, the storage unit 140 and the processor may be embodied as a single chip.

At least one element may be added or omitted according to the performances of the elements of the vehicle 100 illustrated in FIG. 3. Furthermore, it would be apparent to those of ordinary skill in the art that the positions of the elements relative to one another may be changed according to the performance or structure of the system.

The elements illustrated in FIG. 3 may be software elements and/or hardware elements such as a field programmable gate array (FPGA) and an application-specific integrated circuit (ASIC).

A process of estimating a direction in which a sound signal is transmitted and the intensity of the sound signal and determining an alarm sound model matching the sound signal, performed by the controller 130 of the vehicle 100 in accordance with an embodiment, will be described with reference to FIGS. 4 to 6 below.

FIG. 4 is a diagram illustrating a vehicle capable of estimating a direction in which horn sound transmitted from another vehicle and the intensity of the horn sound, in accordance with an embodiment. FIG. 5 is a flowchart of a process of extracting a feature vector of a sound signal, in accordance with an embodiment. FIG. 6 is a conceptual diagram illustrating a process of determining an alarm sound model matching a received sound signal, in accordance with an embodiment.

Referring to FIG. 4, the first microphone 85 of the vehicle 100 functioning as the first sound receiver 111 and the second microphone 86 of the vehicle 100 functioning as the second sound receiver 112 receive a sound signal at different times when another vehicle ob1 in the vicinity of the vehicle 100 generates a sound signal which is a horn sound signal or a siren sound signal. A point of time t1 when the sound signal reaches the first microphone 85 is later than a point of time t2 when the sound signal reaches the second microphone 86 when the other vehicle ob1 is closer to the second microphone 86 than the first microphone 85.

The controller 130 in accordance with an embodiment may calculate the difference (t1−t2) between the point of time t1 when the sound signal reaches the first microphone 85 and the point of time t2 when the sound signal reaches the second microphone 86, and estimate a direction in which the sound signal is transmitted using Equation 1 below.

$$θ = {sin}^{- 1} \frac{d}{2 r} = {sin}^{- 1} \frac{τ c}{2 r} ( τ c < 2 r ) \qquad [ Equation 1 ]$$

In Equation 1 above, c represents the speed of a sound wave in the air, 2γ represents the distance between the first microphone 85 and the second microphone 86, d represents the difference between the point of time when the sound signal reaches the first microphone 85 and the point of time when the sound signal reaches the second microphone 86 (t1−t2 in FIG. 4), and θ represents the direction in which the sound signal is transmitted.

Three or more sound receivers 110 may be provided. When three or more microphones are applied to exactly estimate the position of a source of sound, the position of the source may be estimated from the difference between points of time when the sound reaches, measured by each pair of microphones.

The controller 130 in accordance with an embodiment may determine spatial coordinates of the position of a source of the sound signal using the GCC function other than the difference between the points of time when the sound signal arrives, and estimate the direction in which the sound signal is transmitted on the basis of the spatial coordinates.

In detail, the controller 130 may map the GCC function of Equation 2 below to the spatial coordinates using a mapping function of Equation 3 below and estimate the position of the source.

$${R}_{i} ( τ ) = {\int }_{- ∞}^{∞} \frac{{G}_{i} ( f )}{\vert {G}_{i} ( f ) \vert} {e}^{j 2 π f τ} df \qquad [ Equation 2 ]$$

In Equation 2 above, Gᵢ represents a cross-spectrum density function of sound signals received by an i^{th} pair of microphones, and Rᵢ represents the GCC function. When the first microphone 85 and the second microphone 86 are used, Gi represents the cross-spectrum density function of the sound signal received by the first microphone 85 and the sound signal received by the second microphone 86.

mGCC(θ)=Θ(Rᵢ(τ)) [Equation 3]

In Equation 3 above, Θ represents the mapping function, and mGCC(θ) represents the GCC function mapped to the spatial coordinates.

When three or more microphones are applied to exactly estimate the position of a source of sound, the sum sGCC(θ) of values of the mapped GCC functions mGCC(θ) of respective pairs of microphones may be calculated by Equation 4 below.

$$sGCC ( θ ) = {\sum }_{i = 1}^{M} {mGCC}_{i} ( θ ) \qquad [ Equation 4 ]$$

In Equation 4 above, M represents the number of the pairs of microphones, and sGCC(θ) represents the sum of the values of the mapped GCC functions mGCC(θ) of the respective pairs of microphones.

The controller 130 may determine the direction Gin which the GCC function has a maximum value to be the direction in which the sound signal is transmitted.

Although it is described in the previous embodiment that the direction in which the sound signal is transmitted is determined using the difference between the points of time when the sound signal arrives or the GCC function, a method of determining the direction in which the sound signal is transmitted is not limited thereto.

In order to determine whether the sound signal is alarm sound meaningful to a driver, the controller 130 in accordance with an embodiment determines an alarm sound model matching the sound signal. To this end, the controller 130 transforms a sound signal received for a predetermined time section into a frequency-domain sound signal, divides a frequency band of the frequency-domain sound signal into sub-frequency bands, calculates energies of the sound signal at the sub-frequency bands to extract a feature vector of the sound signal, and determines an alarm sound model matching the feature vector of the sound signal.

In detail, referring to FIG. 5, the controller 130 divides the sound signal in units of predetermined time sections t_{T} (211). When a sound signal in each of the predetermined time sections t_{T} is a frame, the sound signal in an arbitrary n^{th} time section may be referred to as an n^{th} frame (212).

Next, the controller 130 performs Fourier Transformation (FT) or Fast Fourier Transformation (FFT) on the n^{th} frame to transform the sound signal from a time-domain signal to a frequency-domain signal (213).

Then, the controller 130 transforms a scale of the frequency-domain sound signal to the mel scale as in Equation 5 below, and divides the mel-scale of the frequency-domain sound signal in a unit of at least one frequency band, thereby generating at least one filter bank (214). In this case, a frequency bandwidth of the at least one filter bank is determined by Equation 6 below.

$$Mel ( f ) = 2595 \times {log}_{10} ( 1 + \frac{f}{700} ) \qquad [ Equation 5 ]$$

In Equation 5 above, f represents the frequency-domain sound signal before the scale thereof is transformed to the mel scale, and Mel(f) represents the frequency-domain sound signal (i.e., a frequency response) after the scale of the frequency-domain sound signal is transformed to the mel scale.

$$BW = \{ \begin{matrix}1000 , & f < 1000 \\ 25 + {75 [ 1 + 1.4 {( \frac{f}{1000} )}^{2} ]}^{0.69} , & f > 1000\end{matrix} \qquad [ Equation 6 ]$$

In Equation 6 above, BW represents the frequency bandwidth of the at least one filter bank, and f represents a frequency of the sound signal transformed to the mel scale.

Then, the controller 130 calculates energies E₁, E₂, and E₃ of the at least one filter bank of the n^{th} frame (215), and calculates a Mel-frequency cepstrum coefficients (MFCC) vector of the n^{th} frame on the basis of the energies E₁, E₂, and E₃ (216).

A method of calculating the energies E₁, E₂, and E₃ of the at least one filter bank of the n^{th} frame is as expressed in Equation 7 below.

$${E}_{mel} ( n , l ) = \frac{1}{{A}_{l}} {\sum }_{k = {L}_{l}}^{{H}_{l}} {\vert {R}_{l ( {w}_{k} )} X ( n , {w}_{k} ) \vert}^{2} \\ {A}_{l} = {\sum }_{k = {L}_{l}}^{{H}_{l}} {\vert {R}_{l} ( {w}_{k} ) \vert}^{2} \qquad [ Equation 7 ]$$

In Equation 7 above, Emel(n, l) represents energy E₁ of the i^{th} filter bank of the n^{th} frame, Rᵢ(wk) represents a frequency response of the i^{th} filter bank, X(n, wk) represents a frequency response of the n^{th} frame, and LₗHₗ represents upper and lower values of a frequency band of the i^{th} filter bank which are not ‘0’.

A method of calculating the MFCC vector of the n^{th} frame is as expressed in Equation 8 below.

$${C}_{mel} [ n , m ] = \frac{1}{R} {\sum }_{l = 0}^{R - 1} log \{ {E}_{mel} ( n , l ) \} cos ( \frac{2 π}{R} l m ) \qquad [ Equation 8 ]$$

In Equation 8 above, R represents the number of filter banks of the n^{th} frame, and Cmel[n, m] represents an m^{th} coefficient vector of the n^{th} frame.

The calculated MFCC vector may be a feature vector of the sound signal.

Although it is described in the previous embodiment that the feature vector of the sound signal is extracted using an MFCC method, a method of extracting the feature vector of the sound signal is not limited thereto.

The controller 130 in accordance with an embodiment compares the feature vector of the sound signal with at least one alarm sound model stored beforehand, and estimates an alarm sound model matching the feature vector of the sound signal.

Referring to FIG. 6, for example, when a first model S1, a second model S2, and a third model S3 are stored as the at least one alarm sound model, the first model S1 is a horn sound model, the second model S2 is a siren sound model, and the third model S3 is a voice model, the controller 130 determines that an alarm sound model most similar to the feature vector of the sound signal received from the sound receiver 110 is the first model S1.

The alarm sound models S1, S2, and S3 may be stored beforehand in the memory of the controller 130 or data thereof may be stored in the storage unit 140.

In addition, weights may be assigned to the respective alarm sound models S1, S2, and S3. In this case, the controller 130 may determine a weight assigned to the alarm sound model most similar to the feature vector of the input sound signal, and control the output unit 120 to output various outputs according to the weight.

For example, in order to determine similarity between the feature vector of the sound signal and the at least one alarm sound model, the controller 130 may estimate an alarm sound model of the sound signal by transforming the feature vector of the sound signal into a model obtained by adding a Gaussian function to the sound signal and determining an alarm sound model matching this model.

In addition, the controller 130 may determine an alarm sound model matching the sound signal according to various methods of determining similarity between a sound signal and an alarm sound model, e.g., a Gaussian Mixture Model (GMM), a Deep Neural Network (DNN), etc.

Furthermore, the controller 130 may control the output unit 120 to output outputs corresponding to the intensity of the sound signal, the direction in which the sound signal is transmitted, and the estimated alarm sound model. Although for convenience of explanation, the vibration output units 41 and 42 of FIG. 1 will be described as examples of the output unit 120 below, embodiments of the output unit 120 are not limited thereto.

FIG. 7 is a diagram illustrating examples of outputs of vibration output units of a vehicle in accordance with an embodiment.

Referring to FIG. 7, a left vibration output unit 41 and a right vibration output unit 42 provided at the driver seat 18L may output an output corresponding to the intensity of a sound signal determined by the controller 130.

For example, the left vibration output unit 41 and the right vibration output unit 42 may increase the intensity or output speed of an output when the intensity of the sound signal increases as another vehicle approaches the vehicle or is greater than or equal to a predetermined reference value, and may decrease the intensity or output speed of an output when the intensity of the sound signal decreases or is less than the predetermined reference value.

Furthermore, the left vibration output unit 41 and the right vibration output unit 42 may output an output corresponding to the direction in which the sound signal is transmitted, the direction being estimated by the controller 130.

For example, the controller 130 may control the left vibration output unit 41 to output an output when the direction in which the sound signal is transmitted is a left direction of the vehicle 100, control the right vibration output unit 42 to output an output when the direction in which the sound signal is transmitted is a right direction of the vehicle 100, and control the left and right vibration output units 41 and 42 to output an output when the direction in which the sound signal is transmitted is a forward or backward direction of the vehicle 100.

Furthermore, the left vibration output unit 41 and the right vibration output unit 42 may output an output corresponding to an alarm sound model estimated by the controller 130.

For example, the controller 130 may control the left vibration output unit 41 and the right vibration output unit 42 to output an output when an alarm sound model corresponding to the sound signal is estimated to be a horn sound model or a siren sound model. However, the controller 130 may control the left vibration output unit 41 and the right vibration output unit 42 not to output an output when the alarm sound model corresponding to the sound signal is estimated to be a voice model or noise other than an alarm sound model.

In addition, if the vehicle 100 is configured to be an autonomous driving vehicle, the controller 130 may control the steering wheel 31 to automatically change a lane or a driving speed of the vehicle 100 based on the intensity of the sound signal, the direction in which the sound signal is transmitted, and the estimated alarm sound model.

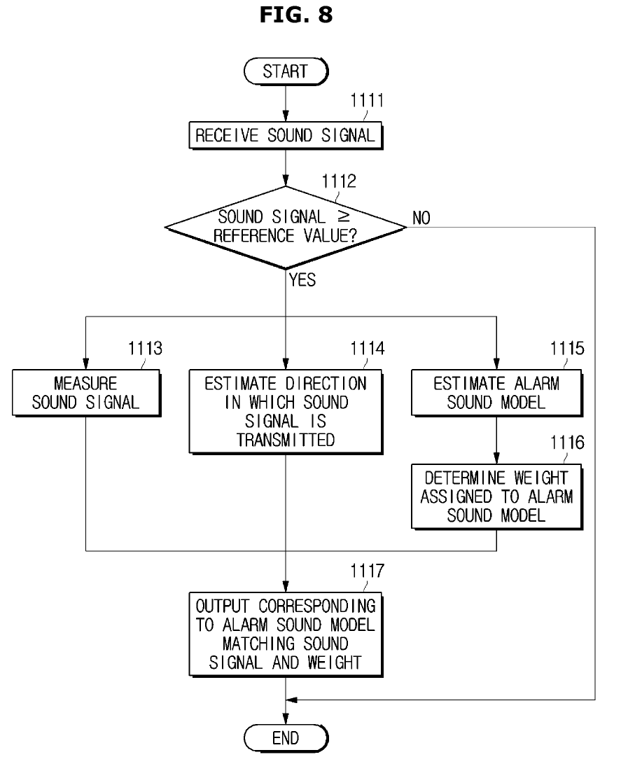

A method of controlling the vehicle 100 in accordance with an embodiment will be described with reference to FIG. 8 below. FIG. 8 is a flowchart of a method of controlling a vehicle in accordance with an embodiment. Elements of the vehicle 100 to be described with reference to FIG. 8 below are the same as the elements of the vehicle 100 described above with reference to FIGS. 1 to 7 and are thus assigned the same reference numerals as the elements of the vehicle 100 described above with reference to FIGS. 1 to 7.

First, a sound receiver 110 of the vehicle 100 in accordance with an embodiment receives a sound signal (1111). Examples of the sound signal include alarm sound which a driver should notice, e.g., horn sound generated by another vehicle in the vicinity of the vehicle 100, sound of a siren of an emergency vehicle, or the like, and noise other than the alarm sound.

Next, a controller 130 of the vehicle 100 in accordance with an embodiment determines whether the intensity of the sound signal is greater than or equal to a predetermined first reference value (1112). When the intensity of the sound signal is greater than or equal to the predetermined first reference value (‘YES’ in 1112), the controller 130 determines that the sound signal is a valid sound signal and measures the intensity of the sound signal (1113), estimates a direction in which the sound signal is transmitted (1114), and estimates an alarm sound model of the sound signal (1115).

When the intensity of the sound signal is measured (1113), the controller 130 may control an output unit 120 to output an output matching the intensity of the sound signal.

For example, the output unit 120 may increase the intensity or output speed of an output when the intensity of the sound signal increases as another vehicle approaches the vehicle 100 or when the intensity of the sound signal is greater than or equal to a second reference value greater than the predetermined first reference value, and may decrease the intensity of output speed of the output when the intensity of the sound signal decreases or is less than the second reference value, according to a control signal from the controller 130.

When the direction in which the sound signal is transmitted is estimated (1114), the controller 130 may control the output unit 120 to output an output corresponding to this direction.

When the alarm sound model of the sound signal is estimated (1115), the controller 130 may determine a weight assigned to the alarm sound model (1116), and control the output unit 120 to output an output corresponding to an alarm sound model matching the sound signal and the weight (1117).

For example, the output unit 120 may output an output only when the alarm sound model matching the sound signal is estimated to be a horn sound model or a siren sound model, according to a control signal from the controller 130.

Furthermore, the output unit 120 may control the intensity or speed of an output differently according to the weight assigned to the matching alarm sound model.

For example, when a weight assigned to a horn sound model is greater than that assigned to a siren sound model and the alarm sound model matching the sound signal is estimated to be the horn sound model, the output unit 120 may output an output having intensity higher than that of the siren sound model or an output at a higher speed than that of the siren sound model.

As is apparent from the above description, when receiving a sound signal, a vehicle in accordance with an embodiment may determine whether the sound signal is noise or alarm sound which should be noticed by a driver and enable the driver to notice only the alarm sound that should be noticed by the driver.

Exemplary embodiments of the present disclosure have been described above. In the exemplary embodiments described above, some components may be implemented as a “module”. Here, the term ‘module’ means, but is not limited to, a software and/or hardware component, such as a Field Programmable Gate Array (FPGA) or Application Specific Integrated Circuit (ASIC), which performs certain tasks. A module may advantageously be configured to reside on the addressable storage medium and configured to execute on one or more processors.

Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The operations provided for in the components and modules may be combined into fewer components and modules or further separated into additional components and modules. In addition, the components and modules may be implemented such that they execute one or more CPUs in a device.

With that being said, and in addition to the above described exemplary embodiments, embodiments can thus be implemented through computer readable code/instructions in/on a medium, e.g., a computer readable medium, to control at least one processing element to implement any above described exemplary embodiment. The medium can correspond to any medium/media permitting the storing and/or transmission of the computer readable code.

The computer-readable code can be recorded on a medium or transmitted through the Internet. The medium may include Read Only Memory (ROM), Random Access Memory (RAM), Compact Disk-Read Only Memories (CD-ROMs), magnetic tapes, floppy disks, and optical recording medium. Also, the medium may be a non-transitory computer-readable medium. The media may also be a distributed network, so that the computer readable code is stored or transferred and executed in a distributed fashion. Still further, as only an example, the processing element could include at least one processor or at least one computer processor, and processing elements may be distributed and/or included in a single device.

While exemplary embodiments have been described with respect to a limited number of embodiments, those skilled in the art, having the benefit of this disclosure, will appreciate that other embodiments can be devised which do not depart from the scope as disclosed herein. Accordingly, the scope should be limited only by the attached claims.

What is claimed is:

1. A vehicle comprising:
a sound receiver to receive a sound signal;
a controller; and
a memory storing a program to be executed in the controller, the program comprising instructions to
estimate an alarm sound model of the sound signal by determining an alarm sound model matching the sound signal among at least one alarm sound model stored beforehand.

2. The vehicle according to claim 1, further comprising:
an output unit to output an output corresponding to the alarm sound model.

3. The vehicle according to claim 2, wherein the program comprises instruction to estimate a direction in which the sound signal is transmitted, and wherein the output unit outputs an output corresponding to the direction in which the sound signal is transmitted and the alarm sound model.

4. The vehicle according to claim 1, further comprising a plurality of sound receivers to receive a plurality of sound signals, wherein the program comprises further instruction to estimate a direction in which the plurality of sound signals is transmitted on the basis of a difference between points of time when the plurality of sound signals are received by the plurality of sound receivers.

5. The vehicle according to claim 1, further comprising a plurality of sound receivers to receive a plurality of sound signals, and wherein the program comprises further instruction to
determine spatial coordinates of a position of a source of the plurality of sound signals using a generalized cross correlation (GCC) function of the plurality of sound signals received by the plurality of sound receivers, and
estimate a direction in which the sound signal is transmitted on the basis of the spatial coordinates.

6. The vehicle according to claim 3, wherein the direction in which the sound signal is transmitted comprises at least one of:
a forward direction of the vehicle;
a backward direction of the vehicle;
a left direction of the vehicle; and
a right direction of the vehicle.

7. The vehicle according to claim 1, wherein the alarm sound model comprises at least one of a horn sound model and a siren sound model of another vehicle.

8. The vehicle according to claim 1, wherein the program comprises further instruction to
read at least one alarm sound model stored in the memory, and
determine an alarm sound model matching the sound signal among the at least one alarm sound model.

9. The vehicle according to claim 1, wherein the program comprises further instruction to
estimate the alarm sound model of the sound signal by transforming a sound signal received for a predetermined time section into a frequency-domain sound signal,
divide a frequency band of the frequency-domain sound signal into sub-frequency bands,
calculate energy of the sound signal in each of the sub-frequency bands to extract a feature vector of the sound signal, and
determine an alarm sound model matching the feature vector of the sound signal.

10. The vehicle according to claim 9, wherein the program comprises further instruction to extract the feature vector of the sound signal according to a Mel-frequency cepstrum coefficients (MFCC) method.

11. The vehicle according to claim 1, wherein the program comprises further instruction to
estimate the alarm sound model of the sound signal by transforming the sound signal into a model obtained by adding a Gaussian function to the sound signal, and
determine an alarm sound model matching this model.

12. The vehicle according to claim 1, wherein the program comprises further instruction to determine the alarm sound model matching the sound signal using at least one of a Gaussian mixture model (GMM) and a deep neural network (DNN).

13. The vehicle according to claim 1, wherein the program comprises further instruction to determine intensity of the sound signal, and wherein the output unit outputs an output corresponding to the intensity of the sound signal and the alarm sound model.

14. The vehicle according to claim 13, wherein the program comprises further instruction to
increase intensity of an output to be output from the output unit or increases speed of the output when the intensity of the sound signal increases or is greater than or equal to a predetermined reference value, and
decrease the intensity or speed of the output when the intensity of the sound signal decreases or is less than the predetermined reference value.

15. The vehicle according to claim 6, wherein the output unit comprises:
a left output unit; and
a right output unit,
wherein the program comprises further instruction to
control the left output unit to output an output when the direction in which the sound signal is transmitted is estimated to be the left direction of the vehicle,
control the right output unit to output an output when this direction is estimated to be the right direction of the vehicle, and
control the left and right output units to output an output when this direction is estimated to be the forward or backward direction of the vehicle.

16. The vehicle according to claim 3, wherein the output unit comprises a vibration output unit to output vibration corresponding to the direction in which the sound signal is transmitted and the alarm sound model.

17. The vehicle according to claim 1, wherein the controller changes a driving speed of the vehicle based on the estimated alarm sound model.

18. A method of controlling a vehicle, the method comprising:
receiving a sound signal;
estimating an alarm sound model of the sound signal,
wherein the estimating of the alarm sound model of the sound signal comprises estimating the alarm sound model of the sound signal by determining an alarm sound model matching the sound signal among at least one alarm sound model stored beforehand.

19. The method according to claim 18, further comprising:
outputting an output corresponding to the alarm sound model.

20. The method according to claim 19, wherein the estimating of the alarm sound model comprises estimating a direction in which the sound signal is transmitted, and wherein the outputting the output comprises outputting an output corresponding to the direction in which the sound signal is transmitted and the alarm sound model.
